(19) United States
(12) Patent Application Publication
(10) Pub. No.: US 2017/0231231 A1
(43) Pub. Date: Aug. 17, 2017

(54) INSECT CONTROL FORMULATIONS

(71) Applicant: Essam ENAN, Davis, CA (US)

(72) Inventor: Essam ENAN, Davis, CA (US)

(21) Appl. No.: 15/422,922

(22) Filed: Feb. 2, 2017

Related U.S. Application Data
(60) Provisional application No. 62/291,546, filed on Feb. 5, 2016.
(60) Provisional application No. 62/358,252, filed on Jul. 5, 2016.

(51) Int. Cl. A01N 65/44; A01N 31/02; A01N 65/22; A01N 65/28; A01N 35/04; A01N 25/04; A01N 37/10; A01N 65/16; A01N 65/06; A01N 65/12; A01N 43/30; A01N 65/32; A01N 65/24; A01N 65/36; A01N 27/00; A01N 43/16; A01N 25/22

(52) U.S. Cl. CPC A01N 65/44; A01N 25/22; A01N 31/02; A01N 65/22; A01N 65/28; A01N 35/04; A01N 25/04; A01N 37/10; A01N 65/16; A01N 65/06; A01N 65/12; A01N 43/30; A01N 65/32; A01N 65/24; A01N 65/36; A01N 27/00; A01N 43/16

(57) ABSTRACT

Exemplary insect repellent, attractant, knockdown and kill compositions may comprise vanillin and two or more active ingredients selected from: geraniol, rosemary oil, winter green oil, methyl salicylate, linalool, tetrahydrolinalool, cedar leaf oil, thyme oil white, thyme oil red, thymol, mint oil, peppermint oil, linseed oil, sunflower oil, piperonal, piperonyl alcohol, benzyl alcohol, lime oil, d-limonene, eucalyptus oil citridora, eucalyptus oil, cinnamon oil, cinnamic alcohol, cinnamyl alcohol, geranium oil, lavender oil, tetrahydrolinalool, phenethyl propionate, clove oil, safflower oil, eugenol, 1,8-cineol, α-terpineol, triethyl citrate, isopropyl myristate, white mineral oil, lemon grass oil, lilac flower oil, black seed cumin oil, geranyl acetate, citric acid, citral diethyl acetal, ascorbic acid, canola oil, corn oil, soybean oil, sandalwood oil, isopropyl alcohol (IPA), pheneythyl alcohol, white mineral oil. The composition may further comprise castor oil based emulsifier, xanthum gum, potassium sorbate, lecithin, sodium lauryl sulfate and/or a diluent, for example.

### BACKGROUND

Field of the Invention

Embodiments relate to insect repellent, attractant knockdown and insecticidal compositions.

Description of the Related Art

As pesticide products were being developed, scientists warned of the dangers of their widespread use. About 80 million pounds per year are the amount of pesticides being used in our homes and on our lawns alone. Several scientific studies have demonstrated that synthetic pesticide products persist longer, travel farther and do more damage to humans, wildlife and the environment than anyone predicted. In addition, insects and other pests have developed resistance against many of the commercially used pesticides. In the field of mosquito and insects repellency DEET (N,N, diethyl-meta-toluamide) is the active ingredient of many commercial insect repellants and is widely used to provide protection against mosquito bites. It can be dispersed into the air, typically being mixed with a carrier solvent and evaporated to provide the repellant effect. Alternatively, it may be applied topically. In various concentrations, it provides its insect repellant effects for several hours. However, DEET suffers from several key disadvantages. It does not occur naturally and requires an involved synthesis. Second, it has known health concerns for people and their pets, such as skin irritation, disorientation, and, in extreme cases, seizures or death. Also, it is not recommended for application to children in concentrations that can be applied to adults. Third, it has an unpleasant odor. Fourth, it acts as a plasticizer and solvent, damaging plastics, synthetic fabrics, and other common materials of its users. In response, the field has sought to develop and use alternative insect repellants. In addition, over time, regulatory agencies have developed lists of components, which impose minimal health risks in use and are demonstrably safe for the intended use. Various non-DEET insect repellant compositions have been developed using naturally occurring compositions and compositions from various regulatory lists. However, those compositions have been deficient, suffering from weaknesses such as duration of efficacy, consistent efficacy during application and use, complicated and involved formulation, difficulty in dispersion, and limited shelf life. Therefore, the need for safer and more potent insect repellents exist. For the above reasons, it would be advantageous to develop an effectual non-DEET based insect repellant.

### SUMMARY

Embodiments are directed to compositions for insect control of mosquitoes and other insects for application to skin, clothes, or as an area repellent. Embodiments are also directed to the development of products to attract, knockdown and kill, but not limited to, mosquito, horse/barn flies and other biting flying and crawling insects. Embodiments may comprise vanillin and two or more active ingredients selected from: geraniol, rosemary oil, winter green oil, methyl salicylate, linalool, tetrahydrolinalool, cedar leaf oil, thyme oil white, thyme oil red, thymol, mint oil, peppermint oil, linseed oil, sunflower oil, piperonal, piperonyl alcohol, benzyl alcohol, lime oil, d-limonene, eucalyptus oil citridora, eucalyptus oil, cinnamon oil, cinnamic alcohol, cinnamyl alcohol, geranium oil, lavender oil, tetrahydrolinalool, phenethyl propionate, clove oil, safflower oil, eugenol, 1,8-cineol, -terpineol, triethyl citrate, isopropyl myristate, white mineral oil, lemon grass oil, lilac flower oil, black seed cumin oil, geranyl acetate, citric acid, citral diethyl acetal, ascorbic acid, canola oil, corn oil, soybean oil, sandalwood oil, isopropyl alcohol (IPA), pheneythyl alcohol, white mineral oil. The composition further comprises one or more of a castor oil based emulsifier, xanthum gum, lecithin, sodium lauryl sulfate. The exemplary composition may further comprise a preservative such as potassium sorbate. The exemplary composition mayfurther comprise a diluent.

One embodiment is a composition comprising vanillin and at least two ingredients selected from the group consisting of: geraniol, rosemary oil, winter green oil, methyl salicylate, linalool, tetrahydrolinalool, cedar leaf oil, thyme oil white, thyme oil red, thymol, mint oil, peppermint oil, linseed oil, sunflower oil, piperonal, piperonyl alcohol, benzyl alcohol, lime oil, d-limonene, eucalyptus oil citridora, eucalyptus oil, cinnamon oil, cinnamic alcohol, cinnamyl alcohol, geranium oil, lavender oil, tetrahydrolinalool, phenethyl propionate, clove oil, safflower oil, eugenol, 1,8-cineol, α-terpineol, triethyl citrate, isopropyl myristate, white mineral oil, lemon grass oil, lilac flower oil, black seed cumin oil, geranyl acetate, citric acid, citral diethyl acetal, ascorbic acid, canola oil, corn oil, soybean oil, sandalwood oil, isopropyl alcohol (IPA), pheneythyl alcohol and white mineral oil.

According to further embodiments, the composition may further comprise an emulsifier selected from the group consisting of a castor oil-based emulsifier, xanthum gum, lecithin and sodium lauryl sulfate. The composition may further comprise a preservative. The composition may further comprise one or more preservatives selected from the group consisting of ascorbic acid, potassium sorbate (C6H7KO2, potassium (2E,4E)-hexa-2,4-dienoate), a sodium benzoate, benzoic acid, sodium nitrite, sulphur dioxide and sodium sorbate, for example.

One embodiment is an insect control composition, comprising: geraniol; thyme oil; lemon grass oil; clove oil; and vanillin.

According to embodiments, the geraniol may be present in the composition between about 10 and about 25% by volume. For example, the geraniol may be present in the composition at about 12% by volume. The thyme oil may be present in the composition between about 1% and about 35% by volume. For example, the thyme oil may be present in the composition at about 5% by volume. The lemon grass oil may be present in the composition between about 1% and about 50% by volume. For example, the lemon grass oil may be present in the composition between at about 5% and about 25% by volume. The clove oil may be present in the composition between about 1% and about 25% by volume. For example, the clove oil may be present in the composition between at about 3% and about 8% by volume. The vanillin, according to one embodiment, may be present in the composition between about 1% to about 15% by volume.

The insect control composition may comprise one or more carrier solvents selected from the group consisting of water, isopropyl alcohol, triethyl citrate, isopropyl myristate, sunflower seed oil, linseed oil, white mineral oil, soybean oil and canola oil. For example, the carrier solvent may comprise corn oil and isopropyl alcohol. The insect control composition may comprise one or more emulsifiers selected from the group consisting of sodium lauryl sulfate, xanthium gum, lecithin, castor oil based derivatives, polyethylene glycol castor oil derivatives and polyoxyethylene castor oil derivatives. The insect control composition may comprise one or more preservatives selected from the group consisting of ascorbic acid, potassium sorbate (C6H7KO2, potassium (2E,4E)-hexa-2,4-dienoate), a sodium benzoate, benzoic acid, sodium nitrite, sulphur dioxide and sodium sorbate. The insect control composition may be configured and/or formulated to repel and/or kill flying and crawling insects.

One embodiment is a method for controlling insects, comprising dispersing into the air and/or applying topically where insect control is desired, an amount of the insect control composition described herein.

Another embodiment is an insect control composition, comprising thyme oil; wintergreen oil; vanillin; and lemon grass oil.

According to embodiments, the thyme oil may be present in the composition between about 1% and about 45% by volume. The wintergreen oil may be present in the composition between about 1% and about 25% by volume. The vanillin may be present in the composition between about 0.1% and about 12% by volume. The lemon grass oil may be present in the composition between about 1% and about 40% by volume.

The insect control composition may further comprise peppermint oil and corn oil. The peppermint oil may be present in the composition between about 1% and about 20% by volume and the corn oil may be present in the composition between about 1% and about 20% by volume.

The insect control composition may further comprise clove oil and triethyl citrate. The clove oil may be present in the composition between about 1% and about 20% by volume and the triethyl citrate may be present in the composition between about 1% and about 40% by volume.

One embodiment of the insect control composition further comprises peppermint oil at about 1% to about 20% by volume; and corn oil at about 1% to about 20% by volume; and the thyme oil is present in the composition between about 1% and about 45% by volume; the wintergreen oil is present in the composition between about 1% and about 25% by volume; the vanillin is present in the composition between about 0.1% and about 12% by volume; and the lemon grass oil is present in the composition between about 1% and about 40% by volume.

One embodiment of the insect control composition further comprises clove oil at about 1% to about 20% by volume; and triethyl citrate at about 1% to about 40% by volume; and the thyme oil is present in the composition between about 1% and about 45% by volume; the wintergreen oil is present in the composition between about 1% and about 25% by volume; the vanillin is present in the composition between about 0.1% and about 12% by volume; and the lemon grass oil is present in the composition between about 1% and about 40% by volume.

These and other features, aspects, and advantages of the compositions described herein will become better understood with reference to the following description, and accompanying drawings.

### BRIEF DESCRIPTION OF THE DRAWINGS

FIG. 1 is a table that shows results of tests of mosquito repellency of compositions comprising plant essential oil mixtures, according embodiments.

FIG. 2 is a table that shows results of tests of mosquito repellency of compositions comprising plant essential oil mixtures, according embodiments.

FIG. 3 is a table that shows results of testing of mosquito repellency by an independent facility, of further compositions according to embodiments.

FIG. 4 is a table that shows a summary repellency comparison between embodiments and several commercial repellent products.

FIG. 5 is a table that shows a summary knockdown and kill of direct spray of compositions according to embodiments (3%) against adult mosquito in 12″×12″ box.

### DETAILED DESCRIPTION

Detailed descriptions of embodiments are provided herein. It is to be understood, however, that implementations thereof may be embodied in various forms. Therefore, specific details disclosed herein are not to be interpreted as limiting, but rather as a basis for the claims and as a representative basis for teaching one skilled in the art to employ the present embodiments in virtually any appropriately detailed system, structure or manner.

The present embodiments are directed to formulations which repel, knockdown, and/or kill insects for insect control. Certain embodiments will be topically applied for repelling insects, specifically, mosquitoes, horse/barn fly, and other biting flies. Certain embodiments are intended as an area repellent. Certain embodiments are insecticidal. Certain embodiments are insecticidal and will be applied as direct spray. Certain embodiments are dust, granules, direct spray, fumigant, fogging or aerosol. Various composition may comprise two or more active ingredients of: geraniol, rosemary oil, winter green oil, methyl salicylate, linalool, tetrahydrolinalool, anise oil, trans-anethole, cedar leaf oil, thyme oil white, thyme oil red, thymol, thymylacetate, linalylacetate, p-cymene, vanillin, pulegon, fenchon, pennyroyal oil, salicylic acid, almond oil, anethole, terpinene-4-ol, nutmeg oil, sabinene, sassafras oil, cypress oil, parsley oil, pipermint oil, pepper oil, linseed oil, sunflower oil, pine oil, piperonal, piperonyl alcohol, benzyl alcohol, lime oil, d-limonene, eucalyptus oil citridora, cassia oil, eucalyptus oil, amyl butyrate, amyl salicylate, camphor, cinnamic alcohol, cinnamic aldehyde, cinnamyl alcohol, b-caryophyllene, sage extract, geranium oil, lavender oil, nerol, tetrahydrolinalool, palm oil, phenethyl propionate, clove oil, linoleic safflower oil, eugenol, 1,8-cineol, lavender oil, carvacrol, jasmine extract, -terpineol, anise oil, triethyl citrate, isopropyl myristate, white mineral oil, lemon grass oil, lilac flower oil, black seed cumin oil, ethyl phenyl acetate, geranyl acetate, citric acid, citral diethyl acetal, ascorbic acid, L-carvone, d-carvone, sesame seed oil, canola oil, corn oil, soybean oil, sandalwood oil, isopropyl alcohol (IPA), pheneythyl alcohol, and white mineral oil. Certain compositions further comprise one or more of Flavonoids and/or alkaloids. Certain compositions also comprise one or more of a castor oil based emulsifier, xanthum gum, potassium sorbate, lecithin, sodium lauryl sulfate. Certain compositions also comprise a diluent.

Certain embodiments include geraniol. In one aspect of these embodiments, the geraniol is present in this formulation at about 0.1% to 99.9%. In another aspect of this embodiment, the geraniol is present in this formulation at about 0.1% to 50%. In yet another aspect of this embodiment, the geraniol is present in this formulation at about 5% to 20%. In yet another aspect of this embodiment, the geraniol is present in this formulation at about 10 to 25%. In this specification weights are by volume unless otherwise specified.

Certain embodiments include thyme oil. The thyme oil of this embodiment is present in this formulation at about 0.1% to 99.9%. In another aspect of this embodiment, the thyme oil is present in this formulation at about 5% to 55%. In yet another aspect of this embodiment, the thyme oil is present in this formulation at about 1% to 35%. In another aspect of this embodiment, the thyme oil is present in this formulation at about 10%.

Certain embodiments include vanillin. In one aspect of this embodiment, the vanillin is present in this formulation at about 1-15%. In another aspect of this embodiment, the vanillin is present in this formulation at about 10%.

Certain embodiments include lemon grass oil. The lemon grass oil is present in this formulation from about 1% to 50%. In another aspect of this embodiment, the lemon grass oil is present in this formulation from about 5% to 25%. In yet another aspect of this embodiment, the lemon grass oil is present in this formulation from about 5% to 25%.

Certain embodiments include rosemary oil. The rosemary oil is present in this formulation from about 1% to 30%. In another aspect of this embodiment, the rosemary oil is present in this formulation from about 5% to 15%. In yet another aspect of this embodiment, the rosemary oil is present in this formulation from about 3% to 10%.

Certain embodiments include clove oil. The clove oil is present in this formulation from about 1% to 25%. In another aspect of this embodiment, the clove oil is present in this formulation from about 5% to 15%. In yet another aspect of this embodiment, the clove oil is present in this formulation from about 3% to 8%.

Certain embodiments include sunflower seed oil. Sunflower seed oil is a non-volatile oil compressed from sunflower seeds. The sunflower oil in this formulation from about 1-30% a.

Certain embodiments include linseed oil. Linseed oil is oil is present in this formulation at about 1% to 15%.

Certain embodiments include cedar leaf oil. In one aspect of this embodiment, the cedar leaf oil is present in this formulation at about 1% to 25%. In another aspect of this embodiment, the cedar leaf oil is present in this formulation at about 2% to 15%. In yet another aspect of this embodiment, the cedar leaf oil is present in this formulation at about 5% to 10%. In yet another aspect of this embodiment, the cedar leaf oil is present in this formulation at about 1% to 5%.

Certain embodiments include soybean oil. The soybean oil is present in this formulation from about 1% to 5%.

Certain embodiments include canola oil. The canola oil is present in this formulation from about 1% to 25%. In another aspect of this embodiment, the canola oil is present in this formulation from about 15% to 25%.

In exemplary composition, a diluent is included in the composition, primarily in order to reduce the viscosity of the insect repellant. The exemplary diluent of this embodiment is water. Alternate suitable diluents are inactive with respect to the other components and have a suitable viscosity for mechanical dispersement. Isopropyl alcohol is one such suitable alternative.

A carrier solvent may be included in the composition, whereby the active components of the composition may be included, enabling the composition to be applied. The exemplary carrier solvent of these embodiments is water. Other suitable carrier solvents include those which are inactive with respect to the other components and have a suitable viscosity for mechanical dispersement. Other suitable carrier solvents include, but are not limited to, isopropyl alcohol, triethyl citrate, isopropyl myristate, sunflower seed oil, linseed oil, white mineral oil, soybean oil and canola oil are representative, suitable alternatives. It should be noted that a single component may have characteristics consistent with both diluents and carrier solvents.

Plant essential oils often have low miscibility with water. Therefore, an emulsifier is included in exemplary embodiments of the compositions in order to support the stability of the composition. Representative suitable emulsifiers are sodium lauryl sulfate, xanthium gum, lecithin, castor oil based derivatives, polyethylene glycol castor oil derivatives and or polyoxyethylene castor oil derivatives. Exemplary castor oil based derivatives include refined castor oil, PEG-40 castor oil and PEG-40 hydrogenated castor oil, POE-36 castor oil, or a composite thereof. The PEG-40 Castor Oil of this embodiment is available from Lambent Technologies Corporation, Rita Corporation, or Ethox under the trade name Lumulse CO-40. The castor oil based derivative is preferably present at greater than 5% concentration. In one aspect, the castor oil based derivative is present from about 5% to 25%. In another aspect, the castor oil based derivative is present from about 10% to 15%.

A preservative is optionally included in the insect repellant and/or killer of the current embodiment in order to inhibit decomposition of the insect control products. The preferred preservative of the current embodiment is ascorbic acid, potassium sorbate (C6H7KO2, potassium (2E,4E)-hexa-2,4-dienoate), although other preservatives, such as benzoates, nitrites, sulphites, and other sorbates may be incorporated. Specifically, representative alternate preservatives include sodium benzoate, benzoic acid, sodium nitrite, sulphur dioxide, or sodium sorbate. In one aspect, the preservative is present from about 0.1% to 1.0%.

For insect control products, the active ingredients, castor oil based emulsifier, and diluent are mixed in proportion to yield, among other characteristics, a maximized insect control, and stability of the emulsion. For example, the proportions of the compositions are selected such that the product is within a desired, substantially effective and constant range for a selected duration, to the extent possible. Whereas the compound geraniol, clove oil, and lemon grass oil tend to have repellency that rapidly decreases over time when used in isolation and the, thyme oil, and linseed oil tend to have delayed repellency when used in isolation, the proportion of each component is adjusted correspondingly. The proportions should be adjusted for synergistic effects between the components. For example, vanillin tends to provide synergy to the active ingredients. Whereas a stable emulsion is necessary for storage and later application of the composition, the proportion of the emulsifier is adjusted according to the miscibility of the composition.

Other examples for insect knockdown and insecticidal properties include but not limited to (1) about 65% thymol, about 20% linalool and about 15% phenethyl propionate, (2) about 10% methyl salicylate, about 20% tetrahydrolinalool, about 10% lime oil and 60% d-limonene, (3) about 45% wintergreen oil (methyl salicylate), and about 10% geraniol, about 25% isopropyl myristate, and about 20% triethyl citrate, (4) about 50% geraniol, about 25% lemon grass oil, 10% vanillin, and about 15% isopropyl alcohol, and (5) about 25% wintergreen oil, about 35% thyme oil, about 20% geraniol, about 12% lemon grass oil and about 8% vanillin. These are just few examples of blend mixtures of the present embodiments and other mixtures will be provided without departing from the scope of the present disclosure. Examples of different methods of using the blends of the present embodiments to control insects are also provided throughout this specification.

Certain formulations are topically applied, directly or sprayed. The insect knockdown and killer may be applied as dust, granules, direct spray, fumigant or aerosol.

### Example 1

This example describes the preparation of an insect repellent product according to an embodiment. The repellent was obtained by mixing the following components: 12% geraniol+5% thyme oil+10% lemon grass oil+3% clove oil+5% vanillin+15% corn oil and 50% IPA. At room temperature and under normal atmospheric pressure, the geraniol, clove oil, thyme oil were added to the reaction vessel and mixed together. Next lemon grass oil and corn oil were added and mixed thoroughly. Isopropyl alcohol was added and the composition was mixed thoroughly. The resulting composition from this mix was introduced to a manual trigger sprayer and applied topically. Landing rates were measured over time to determine the percent repellency.

The complete results are listed in Table 1. Among the several compositions tested, only one of them provided more than 80% protection against mosquito landing and bites up to two hours. The ingredients of this composition are: 12% geraniol, 5% thyme oil, 10% lemon grass oil, 3% clove oil, 5% vanillin, 15% corn oil and 50% isopropyl alcohol (provided 95% repellency).

Independent testing results of this mixture of geraniol, thyme oil, lemon grass oil, clove oil, vanillin, corn oil, and isopropyl alcohol (blend 1) showed higher repellency than several commercial products, including DEET-based repellent as well as a commercial over counter essential oil based product Table 4, appendix 3.

Based on data reported in Tables 1-5 a series of compositions of ingredients in accordance with the present embodiments are presented.

### Example 2

This example describes the preparation of embodiments of an expected repellent and insecticide for flying insects. In some embodiments the insect repellent and killer can be comprised by mixing: geraniol (about 1-20%)+about 1-45% methyl salicylate (winter green oil)+about 1-65% thyme oil+about 1-15% vanillin+about 1-25% lemon grass oil+about 5-60% sunflower oil+about 10-70% IPA.

In certain embodiments, the target insects include flying and crawling insects. Flying insects include but not limited to mosquito, housefly, horse fly, barn fly, biting flies. Crawling insects include but not limited to cockroaches, ants, and spiders.

### Example 3

This example describes the preparation of embodiments of an expected repellent and insecticide for flying insects, that includes but not limited to mosquito, horse and barn flies and other biting flies of the present embodiments. The repellent and insecticide is obtained by mixing the following components: about 5-20% geraniol, about 1-40% methyl salicylate (wintergreen oil), about 0.1-10% vanillin, about 1-55% thyme oil, about 1-25% lemon grass oil.

### Example 4

This example describes the preparation of embodiments of an expected repellent and insecticide for flying insects, that includes but not limited to mosquito, horse and barn flies and other biting flies of the present embodiments. The insect repellent and killer is obtained by mixing the following components: geraniol (5-20%), cedar leaf oil (1-10%), vanillin (0.1-10%), clove oil (1-10%), isopropyl alcohol (10-20%), castor oil (refined) 3%, POE-36 castor oil 9%, potassium sorbate 0.15%, water (remaining).

### Example 5

This example describes the preparation of embodiments of an expected repellent and insecticide for flying insects, that includes but not limited to mosquito, horse and barn flies and other biting flies of the present embodiments. The insect repellent and killer is obtained by mixing the following components: geraniol 5-20%, vanillin 0.1-10%, lemon grass oil (3-20%), clove oil (1-10%), isopropyl alcohol (10-20%), castor oil (refined) 3%, POE-36 castor oil 9%, potassium sorbate 0.15%, water (remaining).

### Example 6

This example describes the preparation of embodiments of an expected repellent and insecticide for flying insects, that includes but not limited to mosquito, horse and barn flies and other biting flies of the present embodiments. The insect repellent and killer is obtained by mixing the following components: geraniol 5-20%+vanillin 0.1-10%+clove oil 1-10%+lemon grass oil 3-20%+IPA (remaining).

### Example 7

This example describes the preparation of embodiments of an expected repellent and insecticide for flying insects, that includes but not limited to mosquito, horse and barn flies and other biting flies of the present embodiments. The insect repellent and killer is obtained by mixing the following components: geraniol 5-20%, vanillin 0.1-10%, clove oil 1-10%, lemon grass oil 3-20%, IPA 10-20%, castor oil (refined) 3%, POE-36 castor oil 9%, potassium sorbate 0.15%, water (remaining).

### Example 8

This example describes the preparation of embodiments of an expected repellent and insecticide for flying insects, that includes but not limited to mosquito, horse and barn flies and other biting flies of the present embodiments. The insect repellent and killer was obtained by mixing the following components: about 5-20% geraniol, about 1-10% cedar leaf oil, about 0.1-10% vanillin, about 9% POE-36 castor oil, about 3% Castor oil (refined), about 0.15% potassium sorbate, remaining water.

### Example 9

This example describes the preparation of an expected repellent and insecticide for flying insects, that includes but not limited to mosquito, horse and barn flies and other biting flies of the present embodiments. The insect repellent and killer is obtained by mixing the following components: about 5-20% geraniol, about 1-10% cedar leaf oil, about 0.1-10% vanillin, about 10-30% canola oil, about 10-80% isopropyl alcohol.

### Example 10

This example describes the preparation of an expected repellent and insecticide for flying insects, that includes but not limited to mosquito, horse and barn flies and other biting flies of the present embodiments. The insect repellent and killer is obtained by mixing the following components: cedar leaf oil 5-20%, vanillin 1-10%, clove oil 1-10%, lemon grass oil 5-15%, isopropyl alcohol (remaining).

### Example 11

This example describes the preparation of an embodiment of an expected repellent and insecticide for flying insects, that includes but not limited to mosquito, horse and barn flies and other biting flies of the present embodiments. The insect repellent and killer is obtained by mixing the following components: cedar leaf oil 5-20%, vanillin 1-10%, clove oil 1-10%, lemon grass oil 5-15%, IPA 10-20%.

### Example 12

This example describes the preparation of an embodiment of an expected repellent and insecticide for flying insects, that includes but not limited to mosquito, horse and barn flies and other biting flies of the present embodiments. The insect repellent and killer is obtained by mixing the following components: cedar leaf oil 5-20%, vanillin 1-10%, lemon grass oil 5-15%, sunflower oil 10-30%, clove oil 1-7%, IPA.

### Example 13

This example describes the preparation of an expected repellent and insecticide for flying insects, that includes but not limited to mosquito, horse and barn flies and other biting flies of the present embodiments. The insect repellent and killer is obtained by mixing the following components: cedar oil 5-20%, geraniol 5-20%, piperonal 5-15%, piperonyl alcohol 1-20%, vanillin 1-10%, lemon grass oil 5-15%, black seed oil 10-30%, IPA.

### Example 14

This example describes the preparation of an expected repellent and insecticide for flying insects, that includes but not limited to mosquito, horse and barn flies and other biting flies of the present embodiments. The insect repellent and killer is obtained by mixing the following components: about 5-16% geraniol, about 1-35% mint oil or peppermint oil, about 1-45% wintergreen oil or methyl salicylate, about 0.1-25% cinnamon oil or cinnamon alcohol, about 1-8% vanillin, about 1-20% lemon grass oil, about 15-45% canola oil, about 40 80% IPA.

### Example 15

This example describes the preparation of an embodiment of a repellent and killer for flying insects, that includes but not limited to mosquito, horse and barn flies and other biting flies of the present embodiments. The insect repellent and killer is obtained by mixing the following components: about 1-15% clove oil, about 1-55% thyme oil, about 1-45% mint oil or peppermint oil, 5-16% geraniol, about 1-7.5% vanillin, about 1-20% lemon grass oil, about 15-45% triethyl citrate, about 40 80% IPA.

### Example 16

This example describes the preparation of an expected repellent and insecticide for flying insects, that includes but not limited to mosquito, horse and barn flies and other biting flies of the present embodiments. The insect repellent and killer is obtained by mixing the following components: about 0.1-99% geraniol, about 0.1-99% cinnamon oil, about 0.1-99% mint oil or peppermint oil, about 0.1-10% vanillin, about 1-35% lemon grass oil.

### Example 17

This example describes the preparation of an embodiment of a repellent and killer for flying insects, that includes but not limited to mosquito, horse and barn flies and other biting flies of the present embodiments. The insect repellent and killer was obtained by mixing the following components: about 0.1-65% thymol, about 0.1-45% methyl salicylate or wintergreen oil, about 0.1-50% tetrahydrolinalool, about 0.1-65% linalool, about 0.1-20% lime oil, about 1-90% d-limonene.

### Example 18

This example describes the preparation of an expected repellent and insecticide for flying insects, that includes but not limited to mosquito, horse and barn flies and other biting flies of the present embodiments. The insect repellent and killer is obtained by mixing the following components: about 0.1-65% thymol, about 0.1-50% tetrahydrolinalool, about 0.1-65% linalool, about 0.1-20% lime oil, about 1-90% d-limonene, about 1-35% white mineral oil.

### Example 19

This example describes the preparation of an expected repellent and insecticide for flying insects, that includes but not limited to mosquito, horse and barn flies and other biting flies of the present embodiments. The insect repellent and killer is obtained by mixing the following components: about 0.1-65% thyme oil, about 0.1-50% tetrahydrolinalool, about 0.1-65% linalool, about 0.1-50 eucalyptus %, about 1-25%-terpineol, about 0.1-20% lime oil, about 1-90% d-limonene, about 1-35% black seed cumin oil.

### Example 20

This example describes the preparation of an expected repellent and insecticide for flying insects, that includes but not limited to mosquito, horse and barn flies and other biting flies of the present embodiments. The insect repellent and killer is obtained by mixing the following components: about 0.1-65% thymol, about 0.1-50% methyl salicylate or wintergreen oil, about 1-25% 1,8-cineol, about 0.1-35% triethyl citrate, about 1-25% lemon grass oil, about 1-8% vanillin.

### Example 21

This example describes the preparation of an expected repellent and insecticide for flying insects, that includes but not limited to mosquito, horse and barn flies and other biting flies of the present embodiments. The insect repellent and killer is obtained by mixing the following components: about 0.1-65% thymol, about 0.1-50% methyl salicylate or wintergreen oil, about 1-25% phenethyl propionate, about 0.1-35% triethyl citrate, about 1-25% isopropyl myristate, about 1-8% white mineral oil.

### Example 22

This example describes the preparation of an expected repellent and insecticide for flying insects, that includes but not limited to mosquito, horse and barn flies and other biting flies of the present embodiments. The insect repellent and killer is obtained by mixing the following components: about 0.1-65% benzyl alcohol, about 1-25% phenethyl propionate, about 1-35%-terpineol, about 0.1-35% triethyl citrate, about 1-25% isopropyl myristate, about 1-45% canola oil, about 1-50% IPA.

These examples describe the preparation of an embodiment of a repellent and killer for flying insects, that includes but not limited to mosquito and other biting flies. These insects repellents and killers were obtained by mixing the following components to achieve the following blends: (1) about 1-20% peppermint oil, about 1-45% thyme oil, about 1-25% wintergreen oil or methyl salicylate, about 0.1-12% vanillin, about 1-40% lemon grass oil, about 20% corn oil or vegetable oil, about 20%-80% isopropyl alcohol; (2) about 1-20% clove oil, about 1-35% thyme oil, about 1-20% wintergreen oil or methyl salicylate, about 0.1-12% vanillin, about 1-40% lemon grass oil, about 1-40% triethyl citrate; (3) about 1-20% clove oil, about 1-15% peppermint oil, about 1-35% thyme oil, about 1-25% wintergreen oil or methyl salicylate, about 0.1-15% vanillin, about 1-40% lemon grass oil; (4) about 1-20% peppermint oil, about 1-45% geraniol, about 1-35% wintergreen oil or methyl salicylate, about 0.1-12% vanillin, about 1-50% lemon grass oil, about 20%-80% isopropyl alcohol; (5) about 1-20% peppermint oil, about 1-35% thyme oil, about 1-30% geraniol; about 1-25% wintergreen oil or methyl salicylate, about 0.1-12% vanillin, about 1-40% lemon grass oil, about 20%-80% isopropyl alcohol.

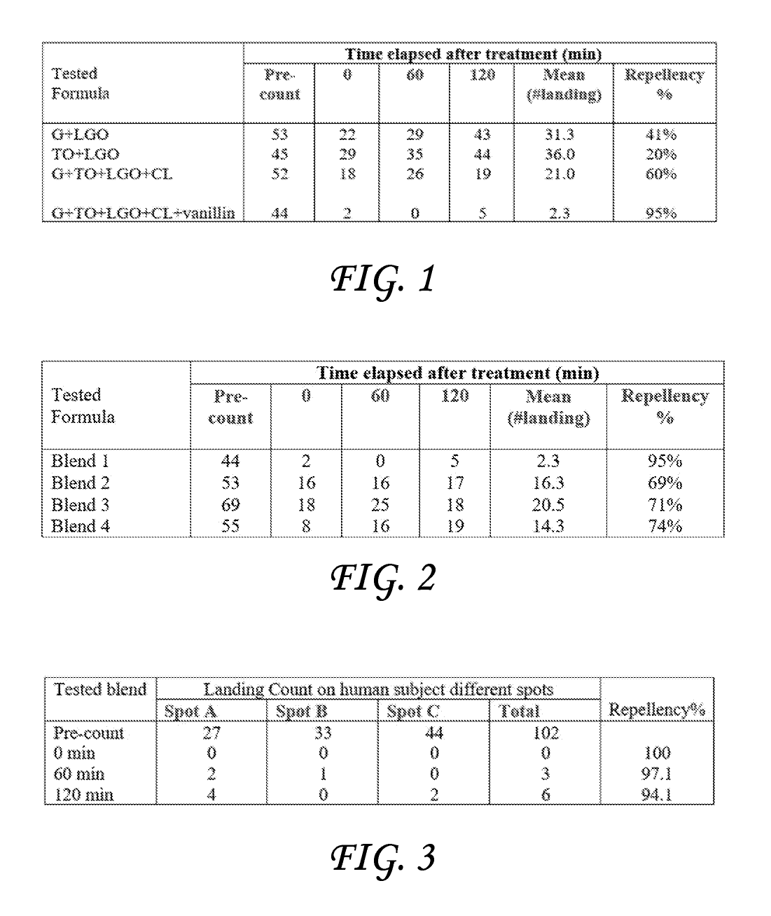

FIG. 1 is a table that shows results of tests of mosquito repellency of compositions comprising plant essential oil mixtures according embodiments. FIG. 2 is a table that shows results of tests of mosquito repellency of compositions comprising plant essential oil mixtures, according embodiments. Table 1 shows the results of an outdoor repellency assay conducted between April to October 2013 in Putah Creek park, in Davis, Calif. Two minutes pre-count was recorded before treatment. The tested formula according to one embodiment was sprayed on the two arms, one leg and neck. A two-minutes count was recorded at 0, 60 and 120 min after application. The resulting data were tabulated and the percent repellency was calculated.
Results and Conclusion:

The data demonstrated that none of the tested ingredients in combinations showed in Table 1 provided more than 80% repellency, with the exception Blend 1 (Table 2), which comprises geraniol (G) (12%)+Thyme oil (TO) (5%)+lemon grass oil (LGO) (10%)+clove oil (CL) (3%)+vanillin (5%) in a carrier solvent. In one embodiment, such a carrier solvent may comprise corn oil (15%)+IPA (50%). Unexpected synergy was obtained using Blend 1 when mixing the above-listed ingredients at the above-listed ratios. Blend 2 comprised TO (15%)+V (7%)+CL (3%)+RM (5%) in a carrier solvent such as canola oil (20%) and IPA (50%). Blend 3 was comprised of G (15%)+RM (3%)+V (3%)+TO (4%) in a carrier solvent such as Canola oil (20) and IPA (55%). Lastly, Blend 4 was comprised of G (12%)+CL (3%)+V (3%)+TO (4%)+RM (3%) in a carrier solvent such as Canola oil (20%) and IPA (55%).

All tested ingredients were tested at concentrations that correspond to their concentrations in Blend 1. Count was recorded after each time point for 2 min. Average landing count is the average of counts at 0, 60 and 120 min. Repellency % is the average landing count, as a percentage of pre-count.

The data in Table 1 demonstrated unexpected synergy. Specifically, about 1.6-fold increase in repellency was demonstrated by the addition of vanillin to the mixture of geraniol, thyme oil and lemon grass oil and clove oil as compared to this mixture without vanillin.

FIG. 3 is a table that shows results of testing of mosquito repellency by an independent facility, of further compositions according to embodiments. Table 3 shows repellency data for the composition of Blend 1 (G+TO+LGO+CL+vanillin in FIG. 1 and Blend 1 in FIG. 2). As shown, the data demonstrated that Blend 1 's on-skin repellent provided more than 90% protection up to 120 minutes.

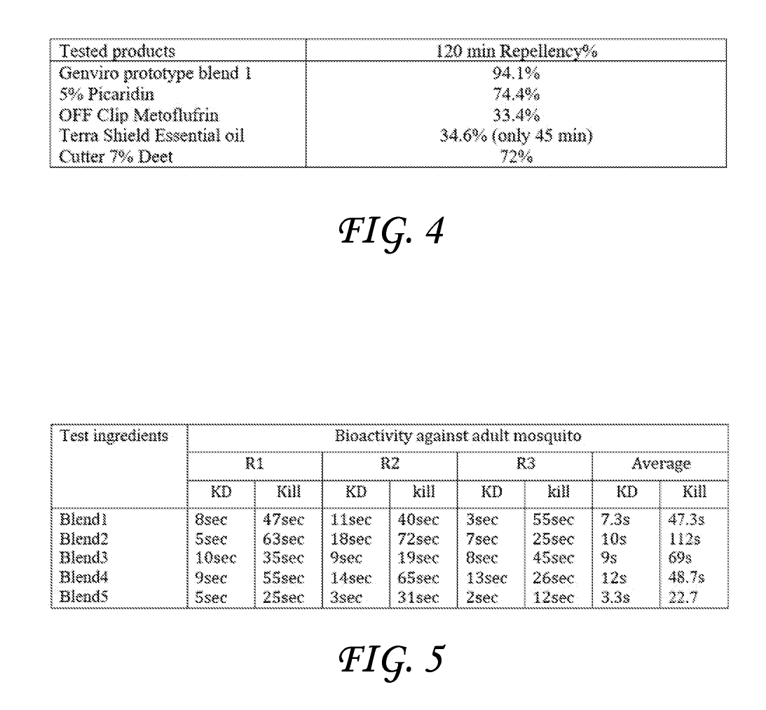

FIG. 4 is a table that shows a summary repellency comparison between embodiments and several commercial repellent products.

As shown therein, the repellency of Blend 1 (94.1%) shown and described relative to FIGS. 1 and 2, according to one embodiment, was compared to a number of commercial repellent products including 5% Picaridin (74.4% repellency), OFF Clip Metoflufrin (33.4% repellency), Terra Shield Essential oil (34.6% repellency, only for 45 min) and Cutter 7% Deet (72% repellency).

### CONCLUSION

Based on all data above (Tables 1-4 of FIGS. 1-4) it can be concluded that mixing Geraniol with thyme oil, lemon grass oil and clove oil was more effective than any two of them. However, a mixture of the four ingredients did not provide acceptable repellency for 1 or 2 hours after application. Surprisingly, however, the addition of vanillin to a mixture of geraniol, thyme oil, clove oil and lemon grass oil, according to one embodiment, induced remarkable repellency (˜95%). Therefore, it can be concluded that the mixture of all five ingredients as described in Blend 1 (Table 1) induced unexpected synergy against mosquito (Tables 1 and 2). Indeed, the data in Table 1 demonstrated about 1.6-fold increase in repellency by the addition of vanillin to a mixture comprising, for example, geraniol, thyme oil, clove oil and lemon grass oil, as compared to the mixture without vanillin.

Data from independent repellency testing was consistent with the early data of FIGS. 1 and 3. The present embodiments of on-skin essential oil blend repellent performed better than several commercial products including Deet-based repellent as well as essential oil-based products.

FIG. 5 is a table that shows a summary knockdown and kill of direct spray of compositions according to embodiments (3%) against adult mosquito in 12″×12″ box. As shown, Table 5 details the effect of direct spray of (3%) blends according to embodiments, against adult mosquito in a 12″×12″ box. Three replicas R1-R3 of 12″×12″ screen boxes were used in the test. Ten adult mosquitoes were introduced to each box. Each box was sprayed with 1 ml, 3% of each blend (Blend 1-Blend 5) from 30″ distance using a trigger spray device. Knockdown (KD) and kill results were recorded over time.

In FIG. 5, Blend 1=G (12%)+TO (5%)+LGO (10%)+clove oil (3%)+vanillin (5%) in a carrier solvent such as corn oil (15%) and IPA (50%). Blend 2=TO (15%)+V (7%)+CL (3%)+RM (5%) in a carrier solvent such as canola oil (20%) and IPA (50%). Blend 3=G (15%)+RM (3%)+V (3%)+TO (4%) in a carrier solvent such as Canola oil (20) and IPA (55%). Blend 4=G (12%)+CL (3%)+V (3%)+TO (4%)+RM (3%) in a carrier solvent such as Canola oil (20%) and IPA (55%). Lastly, Blend 5=clove oil 2%, thyme oil 3%, mint oil 1%, geraniol 5%, vanillin 2.5%, lemon grass oil 6% in a carrier solvent such as triethyl citrate 15% and IPA 55%. Overall, Blend 5 exhibited the most bioactivity against adult mosquitoes, with the fastest knockdown and kill times, as compared to Blends 1-4.

While certain embodiments of the disclosure have been described, these embodiments have been presented by way of example only, and are not intended to limit the scope of the disclosure. Indeed, the novel compositions and methods described herein may be embodied in a variety of other forms. Furthermore, various omissions, substitutions and changes in the form of the compositions and methods described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the ingredients, and/or their proportions as a percentage of total volume of the compositions may differ from those described herein and shown in the figures. Depending on the embodiment, certain ingredients described in the examples above may be removed, while others may be added. Also, the ingredients, proportions and/or other characteristics of the described compositions disclosed above may be combined in different ways to form additional embodiments, all of which fall within the scope of the present disclosure. Although the present disclosure provides certain embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims. Moreover, insofar as the description above and the accompanying drawings disclose any additional subject matter, the embodiments are not dedicated to the public and the right to file one or more applications to claim such additional embodiments are reserved.

1. A composition comprising vanillin and at least two ingredients selected from the group consisting of: geraniol, rosemary oil, winter green oil, methyl salicylate, linalool, tetrahydrolinalool, cedar leaf oil, thyme oil white, thyme oil red, thymol, mint oil, peppermint oil, linseed oil, sunflower oil, piperonal, piperonyl alcohol, benzyl alcohol, lime oil, d-limonene, eucalyptus oil citridora, eucalyptus oil, cinnamon oil, cinnamic alcohol, cinnamyl alcohol, geranium oil, lavender oil, tetrahydrolinalool, phenethyl propionate, clove oil, safflower oil, eugenol, 1,8-cineol, α-terpineol, triethyl citrate, isopropyl myristate, white mineral oil, lemon grass oil, lilac flower oil, black seed cumin oil, geranyl acetate, citric acid, citral diethyl acetal, ascorbic acid, canola oil, corn oil, soybean oil, sandalwood oil, isopropyl alcohol (IPA), pheneythyl alcohol and white mineral oil.

2. The composition of claim 1, further comprising an emulsifier selected from the group consisting of a castor oil-based emulsifier, xanthum gum, lecithin and sodium lauryl sulfate.

3. The composition of claim 1, further comprising a preservative.

4. The composition of claim 4, further comprising at least one preservative selected from the group consisting of ascorbic acid, potassium sorbate (C6H7KO2, potassium (2E,4E)-hexa-2,4-dienoate), a sodium benzoate, benzoic acid, sodium nitrite, sulphur dioxide and sodium sorbate.

5. An insect control composition, comprising:
geraniol;
thyme oil;
lemon grass oil;
clove oil; and
vanillin.

6. The insect control composition of claim 5, wherein the geraniol is present in the composition between about 10 and about 25% by volume.

7. The insect control composition of claim 7, wherein the geraniol is present in the composition at about 12% by volume.

8. The insect control composition of claim 5, wherein the thyme oil is present in the composition between about 1% and about 35% by volume.

9. The insect control composition of claim 8, wherein the thyme oil is present in the composition at about 5% by volume.

10. The insect control composition of claim 5, wherein the lemon grass oil is present in the composition between about 1% and about 50% by volume.

11. The insect control composition of claim 10, wherein the lemon grass oil is present in the composition between at about 5% and about 25% by volume.

12. The insect control composition of claim 5, wherein the clove oil is present in the composition between about 1% and about 25% by volume.

13. The insect control composition of claim 12, wherein the clove oil is present in the composition between at about 3% and about 8% by volume.

14. The insect control composition of claim 5, wherein the vanillin is present in the composition between about 1% to about 15% by volume.

15. The insect control composition of claim 5, further comprising at least one carrier solvent selected from the group consisting of water, isopropyl alcohol, triethyl citrate, isopropyl myristate, sunflower seed oil, linseed oil, white mineral oil, soybean oil and canola oil.

16. The insect control composition of claim 15, wherein the carrier solvent comprises corn oil and isopropyl alcohol.

17. The insect control composition of claim 5, further comprising at least one emulsifier selected from the group consisting of sodium lauryl sulfate, xanthium gum, lecithin, castor oil based derivatives, polyethylene glycol castor oil derivatives and polyoxyethylene castor oil derivatives.

18. The insect control composition of claim 5, further comprising at least one preservative selected from the group consisting of ascorbic acid, potassium sorbate (C6H7KO2, potassium (2E,4E)-hexa-2,4-dienoate), a sodium benzoate, benzoic acid, sodium nitrite, sulphur dioxide and sodium sorbate.

19. The insect control composition of claim 5, configured to at least one of repel and kill flying and crawling insects.

20. A method for controlling insects, comprising at least one of dispersing into the air and applying topically where insect control is desired, an amount of the composition of claim 1.

21. An insect control composition, comprising:
thyme oil;
wintergreen oil;
vanillin; and
lemon grass oil.

22. The insect control composition of claim 21, wherein the thyme oil is present in the composition between about 1% and about 45% by volume.

23. The insect control composition of claim 21, wherein the wintergreen oil is present in the composition between about 1% and about 25% by volume.

24. The insect control composition of claim 21, wherein the vanillin is present in the composition between about 0.1% and about 12% by volume.

25. The insect control composition of claim 21, wherein the lemon grass oil is present in the composition between about 1% and about 40% by volume.

26. The insect control composition of claim 21, further comprising peppermint oil and corn oil.

27. The insect control composition of claim 26, wherein the peppermint oil is present in the composition between about 1% and about 20% by volume.

28. The insect control composition of claim 26, wherein the corn oil is present in the composition between about 1% and about 20% by volume.

29. The insect control composition of claim 21, further comprising clove oil and triethyl citrate.

30. The insect control composition of claim 29, wherein the clove oil is present in the composition between about 1% and about 20% by volume.

31. The insect control composition of claim 29, wherein the triethyl citrate is present in the composition between about 1% and about 40% by volume.

32. The insect control composition of claim 21, further comprising:
peppermint oil at about 1% to about 20% by volume; and
corn oil at about 1% to about 20% by volume; and
wherein:
the thyme oil is present in the composition between about 1% and about 45% by volume;
the wintergreen oil is present in the composition between about 1% and about 25% by volume;
the vanillin is present in the composition between about 0.1% and about 12% by volume; and
the lemon grass oil is present in the composition between about 1% and about 40% by volume.

33. The insect control composition of claim 21, further comprising:
clove oil at about 1% to about 20% by volume; and
triethyl citrate at about 1% to about 40% by volume; and
wherein:
the thyme oil is present in the composition between about 1% and about 45% by volume;
the wintergreen oil is present in the composition between about 1% and about 25% by volume;
the vanillin is present in the composition between about 0.1% and about 12% by volume; and
the lemon grass oil is present in the composition between about 1% and about 40% by volume.
